(19) United States
(12) Patent Application Publication
(10) Pub. No.: US 2008/0139207 A1
(43) Pub. Date: Jun. 12, 2008

(54) Apparatus and method for handover in a communication system

(75) Inventors: Jung-Je Son, Gyeonggi-do (KR); Nam-Gi Kim, Gyeonggi-do (KR); Min-Hee Cho, Gyeonggi-do (KR); Jae-Hyuk Jang, Daegu (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/001,530

(22) Filed: Dec. 12, 2007

(30) Foreign Application Priority Data
Dec. 12, 2006 (KR) 126293/2006

(51) Int. Cl. H04Q 7/20

(52) U.S. Cl. 455/437

(57) ABSTRACT

An apparatus and method for performing a handover in a communication system are provided, in which an MS transmits a BR code to a base station, requesting a bandwidth for transmission of a handover indication message, is allocated a bandwidth for transmission of the handover indication message according to the BR code from the base station, and transmits the handover indication message in the allocated bandwidth to the base station.

### CROSS-REFERENCE TO RELATED APPLICATION(S) AND CLAIM OF PRIORITY

This application claims the benefit under 35 ; U.S.C. §119(a) of a Korean Patent Application filed in the Korean Intellectual Property Office on Dec. 12, 2006 and assigned Serial No. 2006-126293, the entire disclosure of which is hereby incorporated by reference.

### TECHNICAL FIELD OF THE INVENTION

The present invention generally relates to a communication system. More particularly, the present invention relates to an apparatus and method for performing a handover in a communication system.

### BACKGROUND OF THE INVENTION

In a communication system, a mobile station (MS) receives a communication service in the service area (i.e., cell of a base station). When the MS moves from the serving base station (BS) to a neighbor BS (i.e., a target BS), it performs a handover to the target BS.

A handover procedure in a conventional communication system will be described below.

FIG. 1 is a diagram illustrating a signal flow for the handover procedure in the conventional communication system.

Referring to FIG. 1, the communication system includes an MS 110, a serving BS 120, a first neighbor BS 130, and a second neighbor BS 140.

The MS 110 sets up a call with the serving BS 120. During the call service, the MS 110 scans base stations by measuring Channel Quality Information (CQIs) (e.g., Carrier-to-Interference and Noise Ratios (CINRs)) of reference signals, for example, pilot signals received from the serving BS 120 or the neighbor base stations 130 and 140 in step 111. The MS 110 determines based on the CINRs whether to change the serving BS, that is, whether to perform a handover.

If the MS 110 determines to change the serving BS from the BS 120 to another BS, it transmits a Mobile Station Handover Request (MOB_MSHO-REQ) message to the serving BS 120 in step 113. The MOB_MSHO-REQ message, which is a Medium Access Control (MAC) protocol message, carries neighbor BS information measured for a handover by the MS 110.

Upon receipt of the MOB_MSHO-REQ message, the serving BS 120 transmits a Handover_notification (HO_notification) message to candidate target base stations, herein the neighbor base stations 130 and 140 in steps 115 and 117. The serving BS 120 detects a list of the candidate target base stations based on the information included in the MOB_MSHO-REQ message. The candidate target BS list may include a plurality of candidate target base stations and the serving BS 120 transmits the HO_notification message to the listed candidate target base stations.

The neighbor base stations 130 and 140 reply to the serving BS 120 with HO_notification response messages in steps 119 and 121. The HO_notification response messages include information about bandwidths and service levels that the neighbor base stations 130 and 140 can support.

The serving BS 120 transmits a Mobile Station Base Station Handover Response (MOB_BSHO-RSP) message for the MOB_MSHO-REQ message to the MS 110 in step 123. The MOB_BSHO-RSP message includes information about recommended base stations.

The MS 110 acquires handover information about the neighbor base stations by the MOB_BSHO-RSP message and transmits a Handover-Indication (HO-IND) message to the serving BS 120, indicating that it will perform a handover to the first neighbor BS 130 in step 125.

The serving BS 120 transmits a Handover_confirm (HO_confirm) message to the first neighbor BS 130, notifying of the handover of the MS 110 in step 127.

The MS 110 performs the handover to the first neighbor BS 130 as a new serving BS by network re-entry.

The HO-IND transmission of the MS will be described in detail with reference to FIG. 2.

FIG. 2 is a timing diagram of HO-IND transmission in the conventional communication system. For description of the transmission and reception of the HO-IND message between the MS and the serving BS, frame n to frame (n+12) are illustrated.

Referring to FIG. 2, the MS transmits a Bandwidth Request ranging code (hereinafter, referred to as a BR code) to the serving BS in step 211. The MS notifies the serving BS of the existence of transmission data by the BR code.

The serving BS allocates a BandWidth (BW) to the MS so that the MS can transmit a BW request, namely a BW request header in the BW, and transmits a message including information about the allocated BW to the MS in step 213.

In step 215, the MS transmits a BW request header for HO-IND transmission to the serving BS.

The serving BS allocates a BW for the HO-IND transmission to the MS and transmits a BW allocation message for HO-IND including information about the allocated BW in step 217.

In step 219, the MS transmits the HO-IND message to the serving BS.

As described above, the MS notifies the serving BS of a target BS by an HO-IND message. In other words, the HO-IND message includes information about the target BS. The serving BS identifies the target BS from the HO-IND message and transmits an HO-confirm message to the target BS.

With reference to FIG. 2, the HO-IND transmission and reception procedure between the MS and the serving BS has been described above. As stated above, the MS transmits the HO-IND message to the serving BS after deciding on a target BS.

In the mean time, the serving BS may fail to receive the HO-IND message. Despite the HO-IND reception failure, the serving BS continues an on-going service (i.e., on-going data transmission), thus dissipating a bandwidth and making a normal handover to the target BS impossible. However, there is no way for the MS to find out whether the serving BS has received the HO-IND message successfully.

In addition, the HO-IND transmission to the serving BS is delayed for some time after the MS decides on the handover. As noted from FIG. 2, the serving BS receives the HO-IND message over a predetermined number of frames after the MS decides on the handover to the target BS. As stated above, the HO-IND reception impedes a normal network re-entry of the MS to the target BS. As a result, a handover time delay increases.

### SUMMARY OF THE INVENTION

To address the above-discussed deficiencies of the prior art, it is a primary object of the present invention is to address at least the problems and/or disadvantages and to provide at least the advantages described below. Accordingly, an aspect of exemplary embodiments of the present invention is to provide a handover apparatus and method for reducing a handover time delay in a communication system.

Another aspect of exemplary embodiments of the present invention is to provide a handover apparatus and method for reducing the time delay of HO-IND transmission/reception in a communication system.

A further aspect of exemplary embodiments of the present invention is to provide a handover apparatus and method for enabling an MS to determine whether an HO-IND message has been successfully received in a communication system.

In accordance with an aspect of exemplary embodiments of the present invention, there is provided a handover method of an MS in a communication system, in which a BR code is transmitted to a BS, requesting a bandwidth for transmission of a handover indication message, a bandwidth for transmission of the handover indication message is allocated to the MS according to the BR code from the BS, and the handover indication message is transmitted in the allocated bandwidth to the BS.

In accordance with another aspect of exemplary embodiments of the present invention, there is provided a handover method of a BS in a communication system, in which a BR code is received from an MS, the BR code requesting a bandwidth for transmission of a handover indication message, and a bandwidth for transmission of the handover indication message is allocated to the MS according to the BR code.

In accordance with a further aspect of exemplary embodiments of the present invention, there is provided a handover apparatus in a communication system, in which an MS transmits a BR code to a BS, requesting a bandwidth for transmission of a handover indication message, is allocated a bandwidth for transmission of the handover indication message according to the BR code from the BS, and transmits the handover indication message in the allocated bandwidth to the BS.

In accordance with still another aspect of exemplary embodiments of the present invention, there is provided a handover apparatus in a communication system, in which a BS receives a BR code from an MS, the BR code requesting a bandwidth for transmission of a handover indication message, and allocates a bandwidth to the MS, for transmission of the handover indication message according to the BR code.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a signal flow for a handover procedure in a conventional communication system;

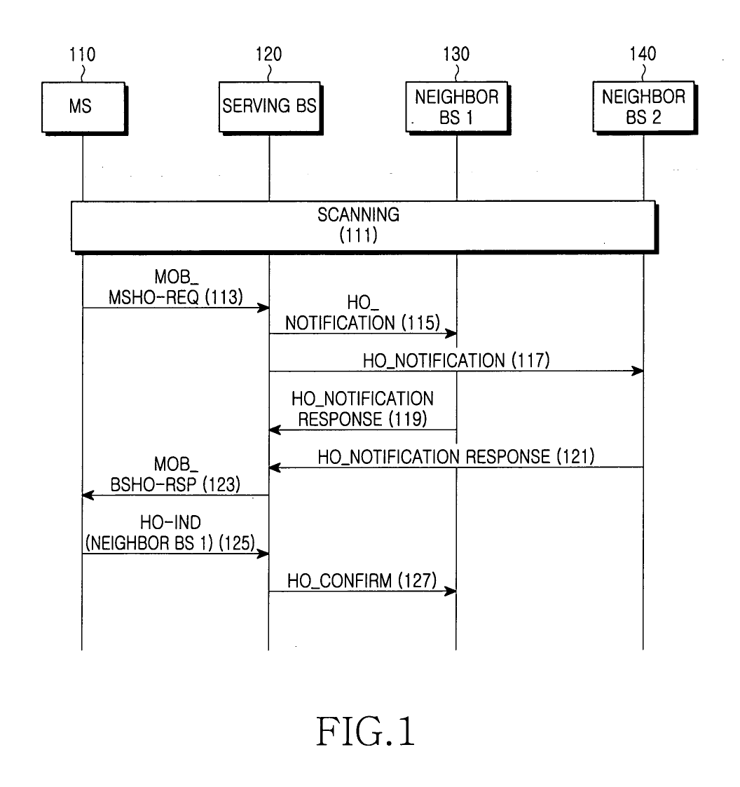

FIG. 2 is a timing diagram of HO-IND transmission in the conventional communication system;

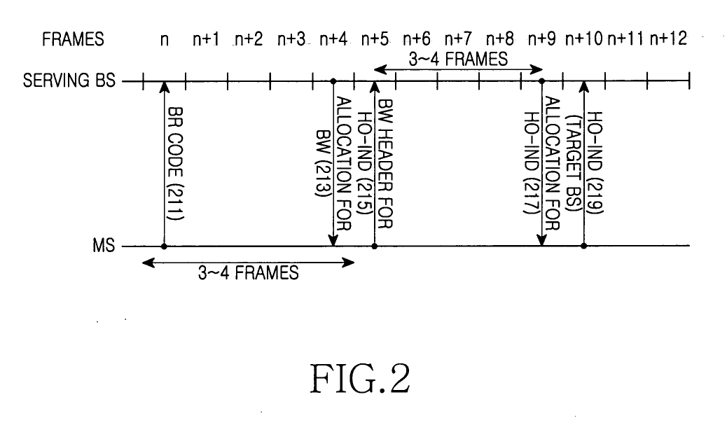

FIG. 3 is a diagram illustrating a signal flow for a handover procedure in a communication system according to an exemplary embodiment of the present invention;

FIG. 4 is a timing diagram of HO-IND transmission in the communication system according to an exemplary embodiment of the present invention;

FIG. 5 is a flowchart of an operation of an MS in relation to HO-IND transmission and HO-IND Acknowledgment (HO-IND ACK) reception according to an exemplary embodiment of the present invention;

FIG. 6 is a flowchart of an operation of a BS in relation to HO-IND reception and HO-IND ACK transmission according to an exemplary embodiment of the present invention;

FIG. 7 is a flowchart of an operation of an MS in relation to HO-IND transmission and HO-IND Negative Acknowledgment (HO-IND NACK) reception according to an exemplary embodiment of the present invention; and

FIG. 8 is a flowchart of an operation of a BS in relation to HO-IND reception and HO-IND NACK transmission according to an exemplary embodiment of the present invention.

### DETAILED DESCRIPTION OF THE INVENTION

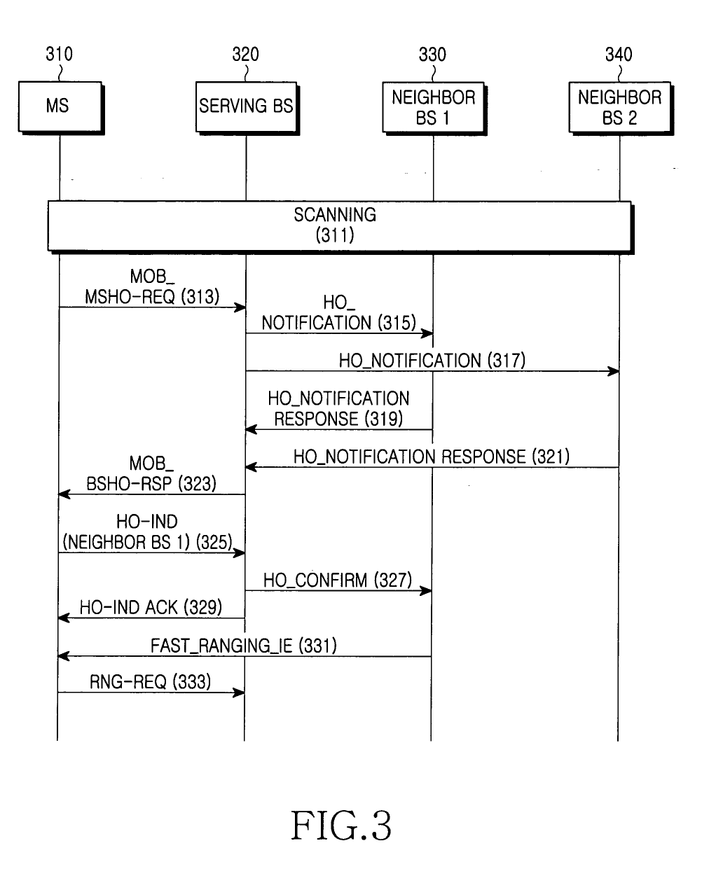

FIGS. 3 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide a handover apparatus and method for transmitting and receiving an HO-IND message in a communication system.

The exemplary embodiments of the present invention provide an HO-IND transmission method in which an MS transmits a BR code for HO-IND transmission to a BS and transmits an HO-IND message in a BW allocated for the HO-IND transmission by the BS. The exemplary embodiments of the present invention also provide an HO-IND ACK or HO-IND NACK message by which it can be determined whether the HO-IND message has been received successfully in a communication system.

With reference to FIG. 3, a handover procedure in a communication system according to an exemplary embodiment of the present invention will be described below.

FIG. 3 is a diagram illustrating a signal flow for the handover procedure in the communication system according to the exemplary embodiment of the present invention.

Referring to FIG. 3, the communication system includes an MS 310, a serving BS 320, a first neighbor BS 330, and a second neighbor BS 340.

The MS 310 sets up a call with the serving BS 320. During the call service, the MS 310 scans base stations by measuring CQIs (e.g., CINRs) of reference signals, for example, pilot signals received from the serving BS 320 or the neighbor base stations 330 and 340 in step 311. The MS 310 determines based on the CINRs whether to change the serving BS, that is, whether to perform a handover.

If the MS 310 determines to change its serving BS from the BS 120 to another BS, it transmits a MOB_MSHO-REQ message to the serving BS 320 in step 313. The MOB_MSHO-REQ message, which is a MAC protocol message, carries neighbor BS information measured for a handover by the MS 310.

Upon receipt of the MOB_MSHO-REQ message, the serving BS 320 transmits an HO_notification message to candidate target base stations, herein the neighbor base stations 330 and 340 in steps 315 and 317. The serving BS 320 detects a list of the candidate target base stations based on the information included in the MOB_MSHO-REQ message. The candidate target BS list may include a plurality of candidate target base stations and the serving BS 320 transmits the HO_notification message to the candidate target base stations.

The neighbor base stations 330 and 340 reply to the serving BS 320 with HO notification response messages in steps 319 and 321. The HO_notification response messages include information about bandwidths and service levels that the neighbor base stations 330 and 340 can support.

The serving BS 320 transmits a MOB_BSHO-RSP message for the MOB_MSHO-REQ message to the MS 310 in step 323. The MOB_BSHO-RSP message includes information about recommended base stations.

The MS 310 acquires handover information about the neighbor base stations by the MOB_BSHO-RSP message and transmits an HO-IND message to the serving BS 320, indicating that it will perform a handover to the first neighbor BS 330 in step 325.

The serving BS 320 transmits an HO_confirm message to the target BS (i.e., the first neighbor BS 330) notifying of the handover of the MS 310 in step 327.

In accordance with the present invention, the serving BS 320 transmits an HO-IND ACK message to the MS 310, indicating successful reception of the HO-IND message in step 329. Thus the MS 310 is aware of the successful HO-IND reception of the serving BS 320 from the HO-ACK message. However, if the MS 310 fails to receive the HO-IND ACK message during a predetermined time period, for example, in a predetermined frame, it retransmits the HO-IND message to the serving BS 320.

Instead of the HO-IND ACK message, the serving BS 320 can use an HO-IND NACK to indicate whether the HO-IND reception is successful or failed. Thus, while not shown in FIG. 3, when the serving BS 320 fails to receive the HO-IND message during a predetermined time period, for example, in a predetermined frame, it transmits the HO-IND NACK message to the MS 310. Upon receipt of the HO-IND NACK message, the MS 310 retransmits the HO-IND message to the serving BS 320. If the MS 310 has not received the HO-IND NACK message, it can consider the HO-IND transmission successful. Thus, the MS 310 performs subsequent handover steps.

To indicate successful or failed HO-IND reception, the serving BS 310 can use both HO-IND ACK and HO-IND NACK messages rather than the HO-IND ACK message or the HO-IND NACK message alone. In this case, for successful reception of the HO-IND message, the serving BS 320 transmits the HO-IND ACK message to the MS 310. If the serving BS 320 fails to receive the HO-IND message during the predetermined time period, it transmits the HO-IND NACK message to the MS 310. Upon receipt of the HO-IND ACK message, the MS 310 performs the subsequent handover steps. Upon receipt of the HO-IND NACK message, the MS 310 retransmits the HO-IND message to the serving BS 320.

In step 331, the target BS (i.e., the first neighbor BS 330), which has received the HO_confirm message, transmits ranging Information Elements (IEs), for example fast ranging IEs (Fast_Ranging_IEs) to the MS 310.

The MS 310 transmits a Ranging-Request (RNG-REQ) message for ranging to the new serving BS (i.e., the first neighbor BS 330) in an uplink BW allocated by the Fast_Ranging_IE message in step 333. If the MS 310 confirms that the serving BS 320 has received the HO_IND message successfully, it performs the handover normally.

In the illustrated case of FIG. 3, if the serving BS 320 fails to receive the HO-IND message, the MS 310 retransmits the HO-IND message to the serving BS 320. Alternatively, the MS 310 can perform the handover without HO-IND retransmission by transmitting an HO ranging code directly to the target BS 330.

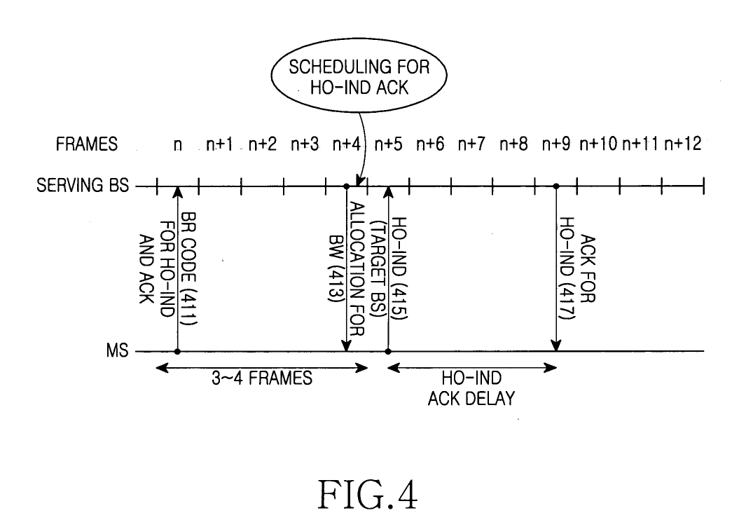

FIG. 4 is a timing diagram of HO-IND transmission in the communication system according to an exemplary embodiment of the present invention. For description of the transmission and reception of the HO-IND message between the MS and the serving BS, frame n to frame (n+12) are illustrated.

Referring to FIG. 4, the MS transmits a BR code to the serving BS in step 411. The MS notifies the serving BS of the existence of transmission data by the BR code. Compared to the conventional technology where the BR code is used for transmission of a BW request header, the present invention uses the BR code for HO-IND transmission.

The serving BS allocates a BW to the MS so that the MS can transmit an HO-IND message in the BW, and transmits a message including information about the allocated BW to the MS in step 413.

In step 415, the MS transmits an HO-IND message to the serving BS.

Conventionally, the BW request header is information that used for requesting a BW for HO-IND transmission. Yet, the MS requests the BW by the BR code and transmits the HO-IND message in the allocated BW, thus reducing the time required for the HO-IND transmission in the present invention.

Compared to the illustrated case of FIG. 3 in which frame n to frame (n+10) are taken to transmit the HO-IND message, frame n to frame (n+5) suffice for the HO-IND transmission in the illustrated case of FIG. 4.

By the BR code, the MS can request a BW for an HO-IND ACK or HO-IND NACK message as well as for the HO-IND message. In the case of using the HO-IND ACK message, the serving BS analyzes the HO-IND message before transmitting the HO-IND ACK message.

Since the serving BS can calculate the time taken for the HO-IND analysis, the transmission time of the HO-IND ACK message following the HO-IND analysis can be preset between the serving BS and the MS. It can be preset that the HO-IND ACK message is transmitted a predetermined time point after HO-IND transmission. For example, the HO-IND ACK transmission time point is represented as a predetermined frame offset from a frame carrying the HO-IND message.

Therefore, the BR code serves the purpose of requesting a BW for the HO-IND message and the HO-IND ACK message. The frame offset for the HO-IND ACK transmission after the HO-IND transmission is known to both the serving BS and the MS.

Upon receipt of the BR code, the serving BS allocates a BW for the HO-IND message and the HO-IND ACK message according to the BR code. The BS transmits the HO-IND ACK message in a frame corresponding to the frame offset from the frame in which the BS receives the HO-IND message. Also, as the serving BS receives the BR code, it schedules HO-IND ACK transmission simultaneously with the BW allocation for the HO-IND message. At the transmission time of the HO-IND ACK message, the BS allocates the BW to the HO-IND ACK message and transmits it in the BW to the MS.

If the MS fails to receive the HO-IND ACK message before or in the frame corresponding to the frame offset from the frame carrying the HO-IND message, it retransmits the HO-IND message to the serving BS or performs network re-entry directly to the target BS by an HO ranging code.

While not shown in FIG. 4, the HO-IND NACK message can be used instead of the HO-IND ACK message. In this case, upon receipt of the BR code, the serving BS determines that the BR code is for transmission of the HO-IND message and the HO-IND NACK message.

For example, the serving BS can set the transmission time of the HO-IND NACK message to a frame spaced by a predetermined frame offset from a frame in which the BS is supposed to receive the HO-IND message from the MS. Upon receipt of the BR code, the BS also allocates a BW for the HO-IND NACK message. If the serving BS fails to receive the HO-IND message during the predetermined time period, for example, before or in the predetermined frame, it transmits the HO-IND NACK message at the transmission time to the MS.

When the MS receives the HO-IND ACK message or does not receive the HO-IND NACK message, it considers the HO-IND transmission successful. If the MS does not receive the HO-IND ACK message or receives the HO-IND NACK message, it retransmits the HO-IND message or performs a handover directly to the target BS using an HO ranging code without HO-IND retransmission. Needless to say, both the HO-IND ACK message and the HO-IND NACK message can be used to indicate whether the HO-IND message has been received successfully.

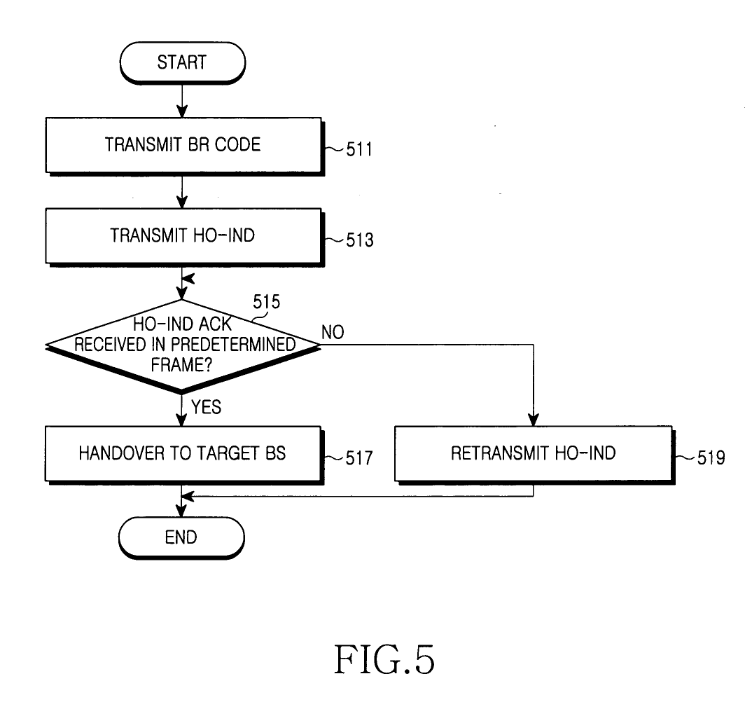

Now a description will be made of transmission of the HO-IND message, the HO-IND ACK message, and the HO-IND NACK message between the MS and the BS. In FIGS. 5 to 8, the BS can be the serving BS communicating with the MS. With reference to FIG. 5, an operation of the MS in relation to HO-IND transmission and HO-IND ACK reception will be described.

FIG. 5 is a flowchart of an operation of the MS in relation to HO-IND transmission and HO-IND ACK reception according to an exemplary embodiment of the present invention.

Referring to FIG. 5, the MS transmits a BR code to the BS in step 511. The BR code is used for transmission of an HO-IND message that carries information about a target BS and for reception of an HO-IND ACK message indicating successful or failed reception of the HO-IND message.

In step 513, a BW is allocated to the MS according to the BR code and the MS transmits the HO-IND message in the BW to the BS.

The MS monitors reception of an HO-IND ACK message during a predetermined time period, for example, in a predetermined frame in step 515. The predetermined time period can be a frame spaced by a predetermined frame offset from a frame carrying the HO-IND message or a frame previous to the frame.

Upon receipt of the HO-IND ACK message from the BS during the predetermined time period, the MS transmits a Fast_Ranging_IE message to a target BS and performs a handover to the target BS in step 517.

If the MS fails to receive the HO-IND ACK message during the predetermined time period, the MS determines that the BS has not received the HO-IND message successfully and retransmits the HO-IND message in step 519. Alternatively, the MS can perform the handover to the target BS directly without HO-IND retransmission.

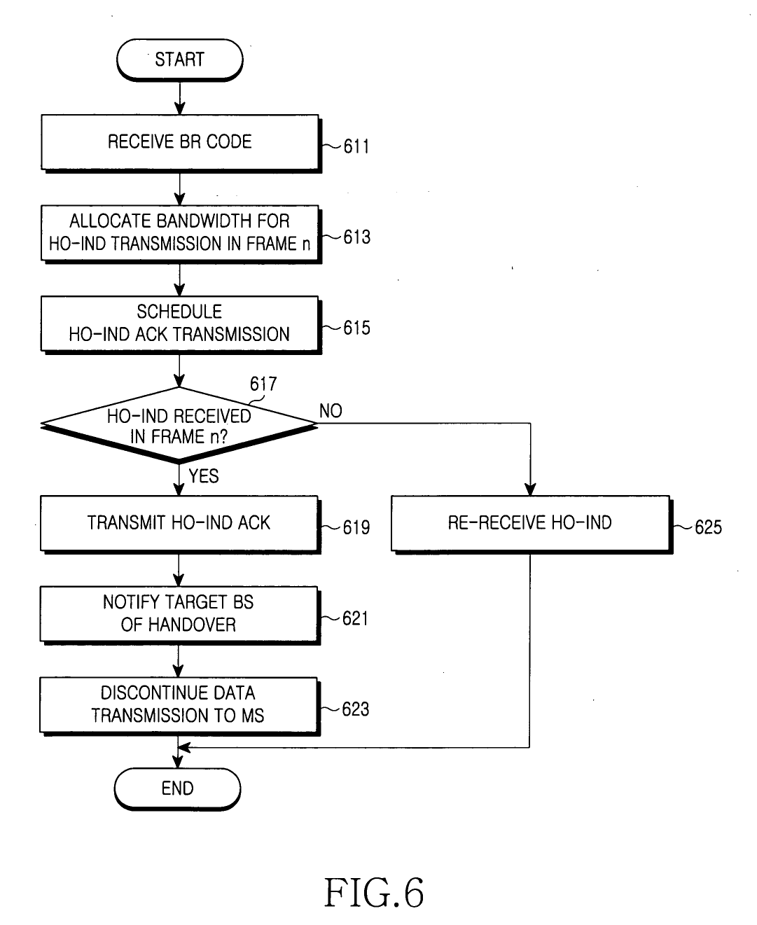

With reference to FIG. 6, an operation of the BS in relation to HO-IND reception and HO-IND ACK transmission will be described.

FIG. 6 is a flowchart of an operation of a BS in relation to HO-IND reception and HO-IND ACK transmission according to an exemplary embodiment of the present invention

Referring to FIG. 6, the BS receives a BR code from the MS in step 611. The BR code is used for transmission of an HO-IND message and transmission of an HO-IND ACK message indicating successful or failed reception of the HO-IND message.

In step 613, the BS allocates a BW to the MS according to the BR code for HO-IND transmission in frame n.

The BS schedules HO-IND ACK transmission in a predetermined frame in step 615 and monitors reception of an HO-IND message in frame n in step 617.

If the BS fails to receive the HO-IND message in frame n, it performs an HO-IND re-reception procedure in step 625.

Upon receipt of the HO-IND message from the MS in frame n, the BS transmits the HO-IND ACK message in the predetermined scheduled frame, for example in a frame spaced by a predetermined frame offset from the frame carrying the HO-IND message in step 619.

In step 621, the BS notifies a target BS of the handover of the MS.

The BS discontinues data transmission to the MS in step 623.

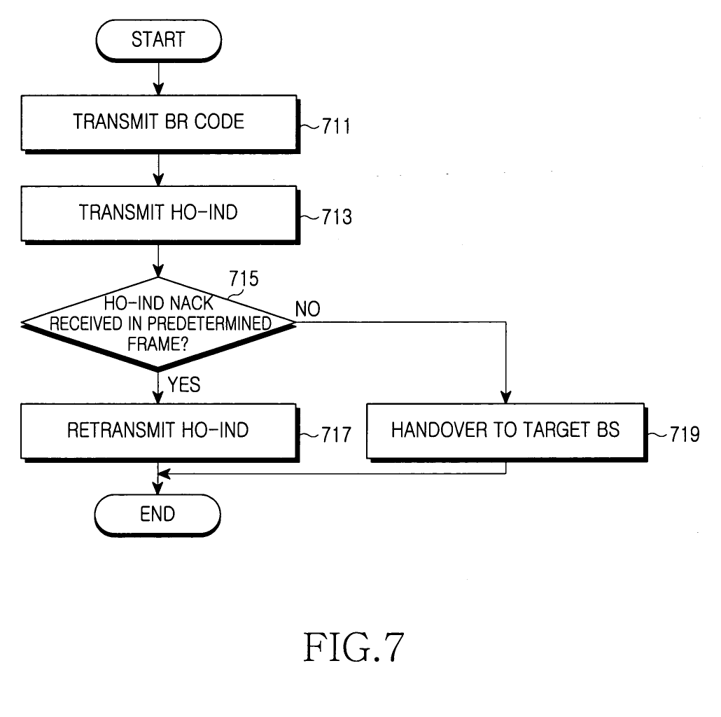

With reference to FIG. 7, an operation of the MS in relation to HO-IND transmission and HO-IND NACK reception will be described.

FIG. 7 is a flowchart of an operation of an MS in relation to HO-IND transmission and HO-IND NACK reception according to an exemplary embodiment of the present invention.

Referring to FIG. 7, the MS transmits a BR code to the BS in step 711. The BR code is used for transmission of an HO-IND message that carries information about a target BS and reception of an HO-IND ACK message indicating successful or failed reception of the HO-IND message.

In step 713, a BW is allocated to the MS according to the BR code and the MS transmits the HO-IND message in the BW to the BS.

The MS monitors reception of an HO-IND NACK message during a predetermined time period, for example, in a predetermined frame in step 715. The predetermined time period can be a frame spaced by a predetermined frame offset from a frame carrying the HO-IND message or a frame previous to the frame.

Upon receipt of the HO-IND NACK message from the BS in the predetermined frame, the MS determines that the BS has not received the HO-IND message successfully and retransmits the HO-IND message in step 717. Alternatively, the MS can perform the handover to the target BS directly without HO-IND retransmission.

If the MS fails to receive the HO-IND NACK message, the MS transmits a Fast_Ranging_IE message to a target BS and performs a handover to the target BS in step 719.

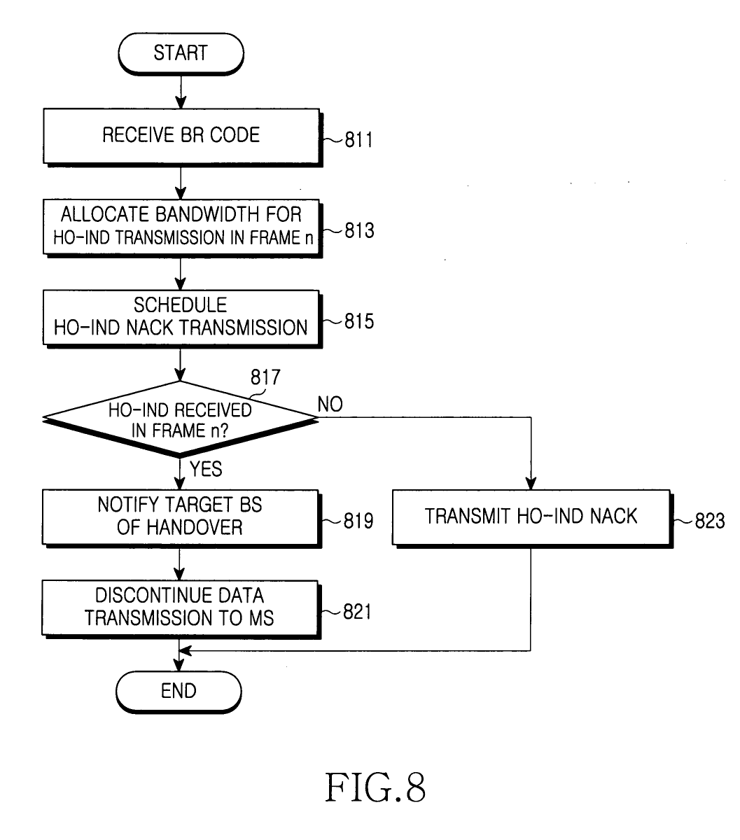

With reference to FIG. 8, an operation of the BS in relation to HO-IND reception and HO-IND NACK transmission will be described.

FIG. 8 is a flowchart of an operation of a BS in relation to HO-IND reception and HO-IND NACK transmission according to an exemplary embodiment of the present invention.

Referring to FIG. 8, the BS receives a BR code from the MS in step 811. The BR code is used for transmission of an HO-IND message and transmission of an HO-IND NACK message indicating successful or failed reception of the HO-IND message.

In step 813, the BS allocates a BW to the MS according to the BR code for HO-IND transmission in frame n.

The BS schedules HO-IND NACK transmission in a predetermined frame in step 815 and monitors reception of an HO-IND message in frame n in step 817.

If the BS fails to receive the HO-IND message in frame n, it transmits the HO-IND NACK message in a predetermined scheduled frame, for example in a frame spaced by a predetermined frame offset from the frame carrying the HO-IND message in step 823. Thus, the BS may perform an HO-IND re-reception procedure.

Upon receipt of the HO-IND message from the MS in frame n, the BS notifies a target BS of the handover of the MS in step 819.

The BS discontinues data transmission to the MS in step 821.

The serving BS is aware that the MS transmits the HO-IND message during a predetermined time period and it can monitor reception of the HO-IND message at its MODEM. Thus, the BS can transmit the HO-IND ACK message after interpreting the HO-IND message. According to the present invention, it can be preset between the BS and the MS by a BR code whether to use an HO_IND_ACK or an HO-IND NACK for the HO-IND message. As the BS preliminarily allocates a BW for transmission of the HO-IND ACK/NACK message, the time taken for the HO-IND ACK/NACK transmission is decreased, enabling fast network reentry to the target BS. The MS can find out the transmission time of the HO-IND ACK/NACK message and thus can perform other operations without waiting to receive the HO-IND ACK/NACK message. It is possible to notify the MS whether the BS has received the HO-IND message successfully by use of the HO-IND ACK message or the HO-IND NACK message alone.

As is apparent from the above description, the present invention advantageously reduces the time required for a handover, that is, a handover time delay by proposing HO-IND transmission and reception procedures in a communication system in which a BW is allocated for HO-IND transmission by a BR code and an HO-IND message is transmitted in the allocated BW. Especially, the time delay of the HO-IND transmission is reduced. Furthermore, since an MS can determine from an HO-IND ACK message or an HO-IND NACK message whether a BS has succeeded or failed in receiving the HO-IND message, the time delay of the handover caused by loss of the HO-IND message is reduced.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A handover method of a Mobile Station (MS) in a communication system, comprising:
transmitting a bandwidth request (BR) code to a base station (BS), the BR code requesting a bandwidth for transmission of a handover indication message;
being allocated a bandwidth for transmission of the handover indication message according to the BR code from the base station; and
transmitting the handover indication message in the allocated bandwidth to the base station.

2. The handover method of claim 1, wherein the bandwidth allocation comprises being allocated a bandwidth for transmission of at least one of a handover indication ACKnowledgment (ACK) message indicating successful reception of the handover indication message and a handover indication Negative ACKnowledgment (NACK) message indicating failed reception of the handover indication message according to the BR code.

3. The handover method of claim 1, further comprising retransmitting the handover indication message, if the mobile station fails to receive a handover indication ACK message indicating successful reception of the handover indication message during a predetermined time point.

4. The handover method of claim 3, further comprising receiving fast ranging information elements and performing a handover to a target base station, if the mobile station receives the handover indication ACK message during the predetermined time point.

5. The handover method of claim 4, wherein the predetermined time point is a frame spaced by a predetermined frame offset from a frame carrying the handover indication message.

6. The handover method of claim 1, further comprising retransmitting the handover indication message, if the mobile station receives a handover indication NACK indicating failed reception of the handover indication message.

7. The handover method of claim 6, further comprising receiving fast ranging information elements and performing a handover to a target base station, if the mobile station fails to receive the handover indication NACK message until a predetermined time point.

8. The handover method of claim 6, wherein the predetermined time point is a frame spaced by a predetermined frame offset from a frame carrying the handover indication message.

9. A handover method of a Base Station (BS) in a communication system, comprising:
receiving a bandwidth request (BR) code from a mobile station (MS), the BR code requesting a bandwidth for transmission of a handover indication message; and
allocating a bandwidth to the mobile station, for transmission of the handover indication message according to the BR code.

10. The handover method of claim 9, further comprising, upon receipt of the handover indication message, scheduling transmission of at least one of a handover indication ACKnowledgment (ACK) message and a handover indication Negative ACKnowledgment (NACK) message at a predetermined time point, the handover indication ACK message indicating successful reception of the handover indication message and the handover indication NACK message indicating failed reception of the handover indication message.

11. The handover method of claim 10, wherein the predetermined time point is a frame spaced by a predetermined frame offset from a frame in which the base station is supposed to receive the handover indication message.

12. The handover method of claim 11, further comprising transmitting the handover indication ACK message, if the base station receives the handover indication message until the predetermined time point and not transmitting the handover indication ACK message, if the base station fails to receive the handover indication message during the predetermined time point.

13. The handover method of claim 11, further comprising not transmitting the handover indication NACK message, if the base station receives the handover indication message until the predetermined time point and transmitting the handover indication NACK message, if the base station fails to receive the handover indication message until the predetermined time point.

14. A handover apparatus in a communication system, comprising:
a mobile station (MS) for transmitting a bandwidth request (BR) code to a base station (BS), the BR code requesting a bandwidth for transmission of a handover indication message, being allocated a bandwidth for transmission of the handover indication message according to the BR code from the base station, and transmitting the handover indication message in the allocated bandwidth to the base station.

15. The handover apparatus of claim 14, wherein the MS is allocated a bandwidth for transmission of at least one of a handover indication ACKnowledgment (ACK) message indicating successful reception of the handover indication message and a handover indication Negative ACKnowledgment (NACK) message indicating failed reception of the handover indication message according to the BR code.

16. The handover apparatus of claim 14, wherein the mobile station retransmits the handover indication message, if the mobile station fails to receive a handover indication ACK message indicating successful reception of the handover indication message until a predetermined time point.

17. The handover apparatus of claim 16, wherein the MS receives fast ranging information elements and performs a handover to a target base station, if the MS receives the handover indication ACK message until the predetermined time point.

18. The handover apparatus of claim 16, wherein the predetermined time point is a frame spaced by a predetermined frame offset from a frame carrying the handover indication message.

19. The handover apparatus of claim 14, wherein the MS retransmits the handover indication message, if the MS receives a handover indication NACK indicating failed reception of the handover indication message.

20. The handover apparatus of claim 19, wherein the MS receives fast ranging information elements and performs a handover to a target base station, if the MS fails to receive the handover indication NACK message until a predetermined time point.

21. The handover apparatus of claim 19, wherein the predetermined time point is a frame spaced by a predetermined frame offset from a frame carrying the handover indication message.

22. A handover apparatus in a communication system, comprising:
a base station (BS) for receiving a bandwidth request (BR) code from a mobile station (MS), the BR code requesting a bandwidth for transmission of a handover indication message, and allocating a bandwidth to the MS, for transmission of the handover indication message according to the BR code.

23. The handover apparatus of claim 22, wherein upon receipt of the handover indication message, the base station schedules transmission of at least one of a handover indication ACKnowledgment (ACK) message and a handover indication Negative ACKnowledgment (NACK) message at a predetermined time point, the handover indication ACK message indicating successful reception of the handover indication message and the handover indication NACK message indicating failed reception of the handover indication message.

24. The handover apparatus of claim 23, wherein the predetermined time is a frame spaced by a predetermined frame offset from a frame in which the base station is supposed to receive the handover indication message.

25. The handover apparatus of claim 24, wherein the base station transmits the handover indication ACK message, if the base station receives the handover indication message until the predetermined time point and does not transmits the handover indication ACK message, if the base station fails to receive the handover indication message until the predetermined time point.

26. The handover apparatus of claim 24, wherein the base station does not transmit the handover indication NACK message, if the base station receives the handover indication message until the predetermined time point and transmits the handover indication NACK message, if the base station fails to receive the handover indication message until the predetermined time point.
